(19) United States
(12) Patent Application Publication
(10) Pub. No.: US 2026/0204938 A1
(43) Pub. Date: Jul. 16, 2026

(54) POWER SUPPLY SYSTEM AND METHOD

(71) Applicant: 3M INNOVATIVE PROPERTIES COMPANY, St. Paul, MN (US)

(72) Inventors: Kevin W. Eberman, St. Paul, MN (US); James F. Poch, New Richmond, WI (US); Douglas D. Jensen, Woodbury, MN (US); Brett A. Howell, Ramsey, MN (US); Patrick R. McKellips, Stillwater, MN (US); David L. Ausen, Eagan, MN (US)

(21) Appl. No.: 19/134,813

(22) PCT Filed: Nov. 30, 2023
(86) PCT No.: PCT/IB2023/062096

§ 371 Date: Jun. 2, 2025

Related U.S. Application Data
(60) Provisional application No. 63/386,064, filed on Dec. 5, 2022.

(51) Int. Cl. H02J 7/00; H01M 50/247; H01M 50/264; H01M 50/296; H02J 7/34; H02J 7/70; H02J 7/90

(52) U.S. Cl. CPC H02J 7/855; H01M 50/247; H01M 50/264; H01M 50/296; H02J 7/34; H02J 7/751; H02J 7/933

(57) ABSTRACT

A power supply system for a portable article of personal protective equipment (PPE) is provided. The portable article of PPE has a housing and an operating unit configured to operate upon supply of electrical power. The power supply system includes an internal battery pack disposed within the housing and configured to selectively supply electrical power to the operating unit. The power supply system further includes an external battery pack configured to be removably attached to or separate from the portable article of PPE and is configured to be selectively electrically connected to at least one of the operating unit and the internal battery pack. The power supply system further includes a controller coupled to at least the internal battery pack and the external battery pack and is configured to electrically connect at least one of the internal battery pack and the external battery pack to the operating unit.

### TECHNICAL FIELD

The present disclosure generally relates to a power supply system, and more particularly, relates to the power supply system for a portable article of personal protective equipment (PPE) and a method of powering the portable article of PPE.

### BACKGROUND

Safety and health of workers are a major concern across many industries. For maintaining worker safety and health, some individuals may be required to don, wear, carry, or otherwise use an article of personal protective equipment (PPE), if the individuals enter or remain in work environments that have hazardous or potentially hazardous conditions. The article of PPE helps protect the safety of the workers.

Generally, electrically powered articles of PPE receive power supply through a battery. In some applications, there may be a need of additional power or an alternative power source to keep the article of PPE functional. Further, as the working environment for the article of PPE is dusty or dirty, the internal components of the article of PPE, such as electrical terminals, may be damaged. For example, the electrical terminals of the article of PPE may experience reduced conductivity upon contact with dust or dirt particles.

### SUMMARY

In a first aspect, the present disclosure provides a power supply system for a portable article of personal protective equipment (PPE) carried by a user. The portable article of PPE has a housing and an operating unit enclosed by the housing and configured to operate upon supply of electrical power. The power supply system includes an internal battery pack non-removably disposed within the housing and configured to selectively supply electrical power to the operating unit. The power supply system further includes an external battery pack configured to be removably attached to or separate from the portable article of PPE. The external battery pack is configured to be selectively electrically connected to at least one of the operating unit and the internal battery pack. The power supply system further includes a controller communicably coupled to at least the internal battery pack and the external battery pack. The controller is configured to electrically connect at least one of the internal battery pack and the external battery pack to the operating unit, such that the operating unit is electrically powered by at least one of the internal battery pack and the external battery pack.

In a second aspect, the present disclosure provides a portable article of PPE. The portable article of PPE includes the power supply system of the first aspect. The portable article of PPE further includes a housing and an operating unit enclosed by the housing. The operating unit is configured to operate upon supply of electrical power.

In a third aspect, the present disclosure provides a method of powering a portable article of personal protective equipment (PPE) carried by a user. The portable article of PPE has a housing and an operating unit enclosed by the housing and configured to operate upon supply of electrical power. The method includes providing an internal battery pack non-removably disposed within the housing and configured to selectively supply electrical power to the operating unit. The method further includes providing an external battery pack configured to be removably attached to or separate from the portable article of PPE. The external battery pack is configured to be selectively electrically connected to at least one of the operating unit and the internal battery pack. The method further includes electrically connecting at least one of the internal battery pack and the external battery pack to the operating unit, such that the operating unit is electrically powered by at least one of the internal battery pack and the external battery pack.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a block diagram illustrating a power supply system for a portable article of personal protective equipment (PPE), according to an embodiment of the present disclosure;

FIG. 2A illustrates a circuit connection between a power supply system and an operating unit of the portable article of PPE of FIG. 1, according to an embodiment of the present disclosure;

FIG. 2B illustrates a circuit connection between the power supply system and the operating unit of the portable article of PPE of FIG. 1, according to another embodiment of the present disclosure;

FIG. 2C illustrates a circuit connection between the power supply system and the operating unit of the portable article of PPE of FIG. 1, according to yet another embodiment of the present disclosure;

FIG. 2D illustrates a circuit connection between the power supply system and the operating unit of the portable article of PPE of FIG. 1, according to yet another embodiment of the present disclosure;

FIG. 2E illustrates a circuit connection between the power supply system and the operating unit of the portable article of PPE of FIG. 1, according to yet another embodiment of the present disclosure;

FIG. 3 is a schematic perspective view of the power supply system and the portable article of PPE of FIG. 1, wherein an external battery pack of the power supply system is removably attached to the portable article of PPE, according to an embodiment of the present disclosure;

FIG. 4A is a schematic perspective view of the power supply system and the portable article of PPE of FIG. 3, wherein the external battery pack is illustrated as detached from the portable article of PPE, according to an embodiment of the present disclosure;

FIG. 4B is a schematic bottom perspective view of a portion of the portable article of PPE of FIG. 3, according to an embodiment of the present disclosure;

FIG. 5A is a schematic perspective view of the power supply system and the portable article of PPE of FIG. 1, wherein an external battery pack of the power supply system is illustrated as detached from the portable article of PPE, according to another embodiment of the present disclosure;

FIG. 5B is a schematic perspective view of the power supply system and the portable article of PPE of FIG. 5A, wherein the external battery pack is removably attached to the portable article of PPE, according to an embodiment of the present disclosure;

FIG. 6A is a schematic perspective view of the power supply system and the portable article of PPE of FIG. 1, wherein an external battery pack of the power supply system is illustrated as detached from the portable article of PPE, according to another embodiment of the present disclosure;

FIG. 6B is a detailed schematic perspective view of the power supply system and the portable article of PPE of FIG. 6A, wherein the external battery pack is removably attached to the portable article of PPE, according to an embodiment of the present disclosure;

FIG. 7A is a schematic front view of the power supply system and the portable article of PPE of FIG. 1, wherein an external battery pack of the power supply system is illustrated as detached from the portable article of PPE, according to another embodiment of the present disclosure;

FIG. 7B is a detailed schematic front view of the power supply system and the portable article of PPE of FIG. 7A, wherein the external battery pack is removably attached to the portable article of PPE, according to an embodiment of the present disclosure;

FIG. 8 is a block diagram illustrating a power supply system for a portable article of PPE, according to another embodiment of the present disclosure;

FIG. 9A is a schematic perspective view of the power supply system and the portable article of PPE of FIG. 8, wherein an external battery pack of the power supply system is separate from the portable article of PPE, according to an embodiment of the present disclosure;

FIG. 9B is a schematic perspective view of the power supply system and the portable article of PPE of FIG. 9A, wherein the external battery pack is fully and removably received within the portable article of PPE, according to an embodiment of the present disclosure;

FIG. 10A is a schematic perspective view of the power supply system and the portable article of PPE of FIG. 8, wherein an external battery pack of the power supply system is separate from the portable article of PPE, according to another embodiment of the present disclosure;

FIG. 10B is a schematic perspective view of the power supply system and the portable article of PPE of FIG. 10A, wherein the external battery pack is fully and removably received within the portable article of PPE, according to an embodiment of the present disclosure;

FIG. 11A is a schematic perspective view of the power supply system and the portable article of PPE of FIG. 8, wherein an external battery pack of the power supply system is separate from the portable article of PPE, according to another embodiment of the present disclosure;

FIG. 11B is a schematic perspective view of the power supply system and the portable article of PPE of FIG. 11A, wherein the external battery pack is fully and removably received within the portable article of PPE, according to an embodiment of the present disclosure;

FIG. 12 is a block diagram illustrating a power supply system for a portable article of PPE, according to another embodiment of the present disclosure;

FIG. 13A is a schematic perspective view of the power supply system and the portable article of PPE of FIG. 12, wherein an external battery pack of the power supply system is electrically disconnected from the portable article of PPE, according to an embodiment of the present disclosure;

FIG. 13B is a schematic perspective view of the power supply system and the portable article of PPE of FIG. 13A, wherein the external battery pack of the power supply system is electrically connected to the portable article of PPE, according to an embodiment of the present disclosure;

FIG. 14A is a schematic perspective view of the power supply system and the portable article of PPE of FIG. 12, wherein an external battery pack of the power supply system is electrically disconnected from the portable article of PPE, according to another embodiment of the present disclosure;

FIG. 14B is a schematic perspective view of the power supply system and the portable article of PPE of FIG. 14A, wherein the external battery pack of the power supply system is electrically connected to the portable article of PPE, according to an embodiment of the present disclosure;

FIG. 15A is a schematic perspective view of the power supply system and the portable article of PPE of FIG. 12, wherein an external battery pack of the power supply system is electrically disconnected from the portable article of PPE, according to another embodiment of the present disclosure;

FIG. 15B is a schematic perspective view of the power supply system and the portable article of PPE of FIG. 15A, wherein the external battery pack of the power supply system is electrically connected to the portable article of PPE, according to an embodiment of the present disclosure; and

FIG. 16 is a flow chart illustrating a method of powering a portable article of personal protective equipment (PPE) carried by a user, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

The term “about”, unless otherwise specifically defined, means to a high degree of approximation (e.g., within +/−5% for quantifiable properties) but again without requiring absolute precision or a perfect match.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “coupled”, or “connected” may include direct physical connections between two or more components, or indirect physical connections between two or more components that are connected together by one or more additional components. For example, a first component may be coupled to a second component by being directly connected together or by being connected by a third component.

As used herein, the term “configured to” and like is at least as restrictive as the term “adapted to” and requires actual design intention to perform the specified function rather than mere physical capability of performing such a function.

The present disclosure relates to a power supply system for a portable article of personal protective equipment (PPE) carried by a user. The portable article of PPE may be a powered air-purifying respirator (PAPR), a self-contained breathing apparatus (SCBA), a protective headwear, mining cap lamps, helmets, a hearing protection device, or any other suitable electrically powered gear carried by a user.

Conventionally, an article of PPE uses an external battery that can be removed from the article of PPE. The removable external battery allows a user to quickly replace a discharged battery with a charged battery and return the article of PPE in a working state. However, as the article of PPE is usually operated in a hazardous environment with dust and dirt particles, the dust particles may contact electrical terminals of the article of PPE and therefore may reduce their conductivity. This may also result in poor functioning system of the external battery and the article of PPE. Further, once the dirt particles are stuck with the electrical terminals, the electrical terminals may be difficult to clean as regions in vicinity of such electrical terminals may have sharp edges, deep grooves, and rough metal surfaces. Additionally, the addition of a removable battery further increases cost, complexity, and weight of the article of PPE.

To avoid the dust particles contacting the electrical terminals of the article of PPE, an internal battery (in-built battery) could be used to electrically power the article of PPE. The internal battery is disposed inside the article of PPE and may be charged though an interface like a USB port, barrel-jack, or other charging connector. The USB port or a barrel jack may be covered with a cover such as a rubber plug to prevent the internal battery from any foreign particles. However, in some cases, the internal battery may not have enough energy available to provide the desired runtime to the article of PPE. As a result, there is a need of additional power supply to keep the article of PPE functional. Further, in some applications, the internal battery may take relatively longer time to recharge causing downtime of the article of PPE.

Therefore, there exists a need for a power supply system that may supply a desirable power to the article of PPE. Moreover, there is also a need to protect the electrical terminals of the article of PPE from any foreign contamination.

The present disclosure provides a power supply system for a portable article of personal protective equipment (PPE) carried by a user. The portable article of PPE has a housing and an operating unit enclosed by the housing and configured to operate upon supply of electrical power. The power supply system includes an internal battery pack non-removably disposed within the housing and configured to selectively supply electrical power to the operating unit. The power supply system further includes an external battery pack configured to be removably attached to or separate from the portable article of PPE. The external battery pack is configured to be selectively electrically connected to at least one of the operating unit and the internal battery pack. The power supply system further includes a controller communicably coupled to at least the internal battery pack and the external battery pack. The controller is configured to electrically connect at least one of the internal battery pack and the external battery pack to the operating unit, such that the operating unit is electrically powered by at least one of the internal battery pack and the external battery pack.

The power supply system of the present disclosure uses the internal battery pack and/or the external battery pack to provide required electrical power to the portable article of PPE for its smooth functioning. In cases where desired runtime of the portable article of PPE is relatively greater than the normal runtime, the power supply system may allow the internal battery pack and the external battery pack to simultaneously supply electrical power to the portable article of PPE. In some cases, the internal battery pack and the external battery pack simultaneously supply electrical power to the portable article of PPE while the internal battery pack is being charged by the external battery pack. In other words, the external battery pack charges the internal battery pack as well as supplies electrical power to the portable article of PPE.

In cases where the desired runtime of the portable article of PPE is substantially same as the normal runtime, the power supply system may allow the internal battery pack to supply electrical power to the portable article of PPE while the internal battery pack is being charged by the external battery pack. In cases where a state of charge of the internal battery pack is less than a predetermined charge threshold, the power supply system may allow the external battery pack to supply electrical power to the portable article of PPE. Alternatively, where the state of charge of the internal battery pack is less than the predetermined charge threshold, the power supply system may allow the external battery pack to charge the internal battery pack as well as supply electrical power to the portable article of PPE. Therefore, the power supply system of the present disclosure may supply a desirable power to the portable article of PPE based on different application attributes.

In some embodiments, the external battery pack is removably attached to the portable article of PPE. The controller is further configured to electrically connect the external battery pack to at least one of the operating unit and the internal battery pack upon removable attachment of the external battery pack to the portable article of PPE. The external battery pack includes a plurality of external terminals. A plurality of housing terminals are disposed on the housing of the portable article of PPE. The plurality of external terminals contact with the plurality of housing terminals upon removable attachment of the external battery pack with the portable article of PPE. The power supply system further includes a cover configured to enclose the plurality of housing terminals upon detachment of the external battery pack from the portable article of PPE. In some embodiments, the external battery pack is remote from the portable article of PPE and is electrically connected to the operating unit of the portable article of PPE via a wireless interface. Therefore, the portable article of PPE may be electrically powered by the external battery pack through a wireless connection. For example, the wireless connection may include a near field or non-radiative technique to transfer power over short distances by magnetic fields using inductive coupling between coils of wire, or by electric fields using capacitive coupling between metal electrodes. Inductive coupling is the most widely used wireless technology.

While using the portable article of PPE in hazardous locations with presence of dust, fumes, dirt particles, etc., the cover may prevent contact of foreign particles (dust, fumes, dirt particles) with the housing terminals of the portable article of PPE that can otherwise reduce conductivity of the housing terminals. Preventing the contact of the foreign particles with the housing terminals of the portable article of PPE may also ensure smooth and proper functioning of the portable article of PPE and the external battery pack. Moreover, inclusion of the cover may also save a lot of time and effort of an operator who had to otherwise remove/clean the foreign particles manually from the internal components (such as the housing terminals) of the portable article of PPE.

Further, the cover has a surface roughness value of about 0.8 μm, which may allow a user to easily clean the cover. The cover may also prevent the accumulation of foreign particles in the housing terminals of the portable article of PPE and therefore prevent the unwanted heating of various components.

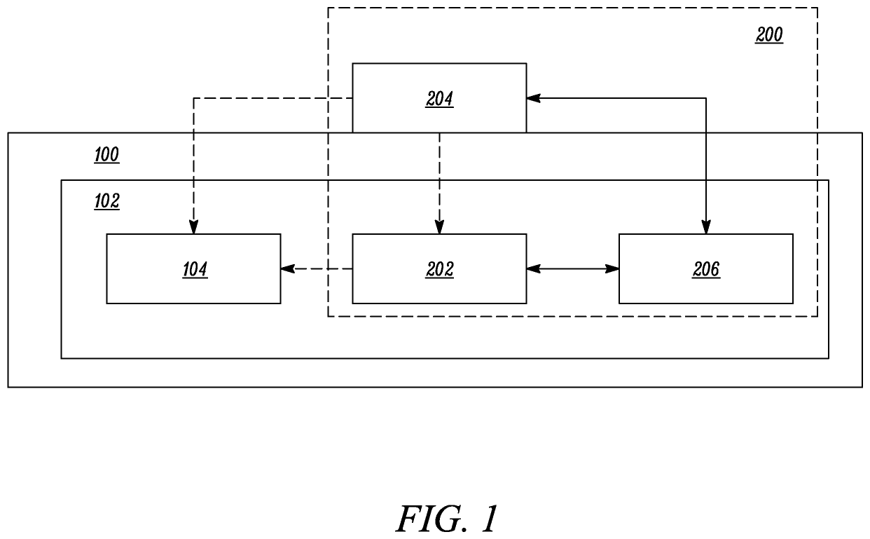

FIG. 1 is a block diagram illustrating a power supply system 200 for a portable article of personal protective equipment (PPE) 100 carried by a user (not shown). The portable article of PPE 100 may be a powered air-purifying respirator (PAPR), a self-contained breathing apparatus (SCBA), a protective headwear, mining cap lamps, helmets, a hearing protection device, or any other suitable electrically powered gear carried by a user. In some embodiments, the portable article of PPE 100 may include the power supply system 200. The portable article of PPE 100 includes a housing 102 and an operating unit 104 enclosed by the housing 102. The operating unit 104 is configured to operate upon supply of electrical power.

In some examples, the operating unit 104 may be a head mounted electronic display, a communication unit, a display unit, an output device such as speaker, a ventilation unit, a filtering unit, a visual indicator, an optical unit such as a camera, or any other component of the portable article of PPE 100 that operates upon supply of electrical power.

The power supply system 200 includes an internal battery pack 202 non-removably disposed within the housing 102 and configured to selectively supply electrical power to the operating unit 104. The internal battery pack 202 may use range of different types of electrochemical cells having Li-ion, NiMH, NiCd or other rechargeable chemistries, and those cells may be in any or a wide range or shapes, such as prismatic, disk, or cylinder. In some embodiments, the internal battery pack 202 includes a plurality of thin-pouch electrochemical cells. In some examples, the thin-pouch electrochemical cells may be electrochemical cells heat sealed in soft aluminum/plastic laminate foil pouches. In some examples, the thin-pouch electrochemical cells may have rectangular, flat-geometry shape having opposed long and short edges. Significantly higher energy density can be achieved for the internal battery pack 202 designed using thin pouch cells.

The power supply system 200 further includes an external battery pack 204 configured to be removably attached to or separate from the portable article of PPE 100. The external battery pack 204 may be a separate component from the portable article of PPE 100. Therefore, the external battery pack 204 can be removed from the housing 102. The external battery pack 204 is configured to be selectively electrically connected to at least one of the operating unit 104 and the internal battery pack 202. In some examples, the external battery pack 204 includes a plurality of cylindrical electrochemical cells. Significantly higher energy density can be achieved for the external battery pack 204 designed using cylindrical electrochemical cells.

The power supply system 200 further includes a controller 206 communicably coupled to at least the internal battery pack 202 and the external battery pack 204. The controller 206 is configured to electrically connect at least one of the internal battery pack 202 and the external battery pack 204 to the operating unit 104, such that the operating unit 104 is electrically powered by at least one of the internal battery pack 202 and the external battery pack 204. In other words, the power supply system 200 uses the internal battery pack 202 and/or the external battery pack 204 to provide required electrical power to the portable article of PPE 100 for its smooth functioning.

In an application, the controller 206 may be a power supply control circuit, a charge controller, a computer, a microprocessor, a microcomputer, microcontroller, a central processing unit, or any suitable device or apparatus. The controller 206 may comprise one or more of a digital processor, an analog processor, a digital circuit designed to process information, an analog circuit designed to process information, a state machine, and/or other mechanisms for electronically processing information.

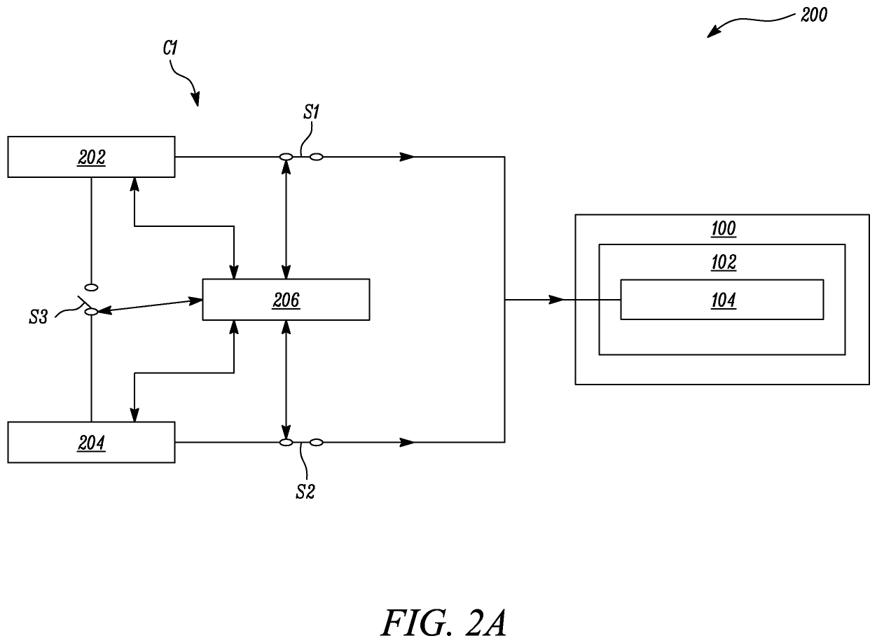

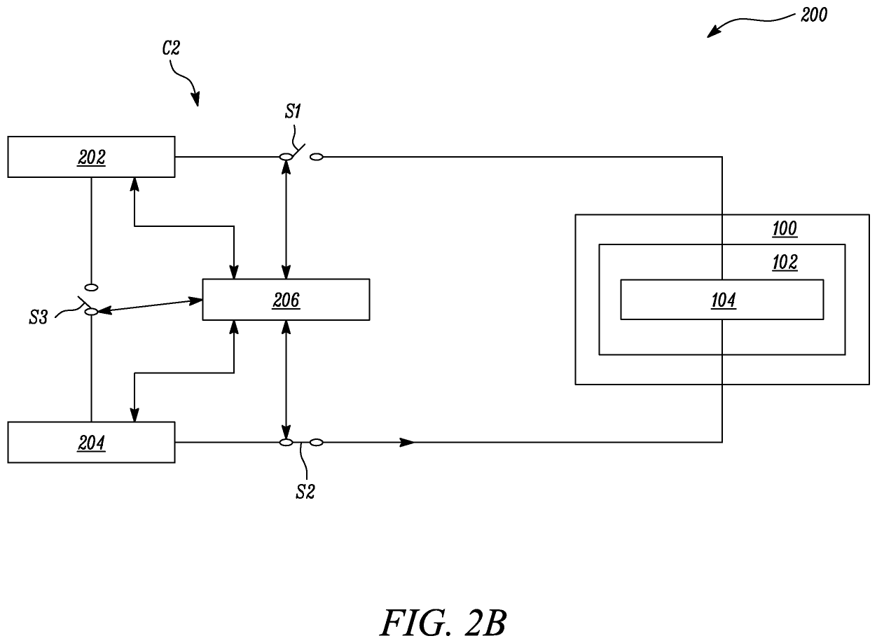

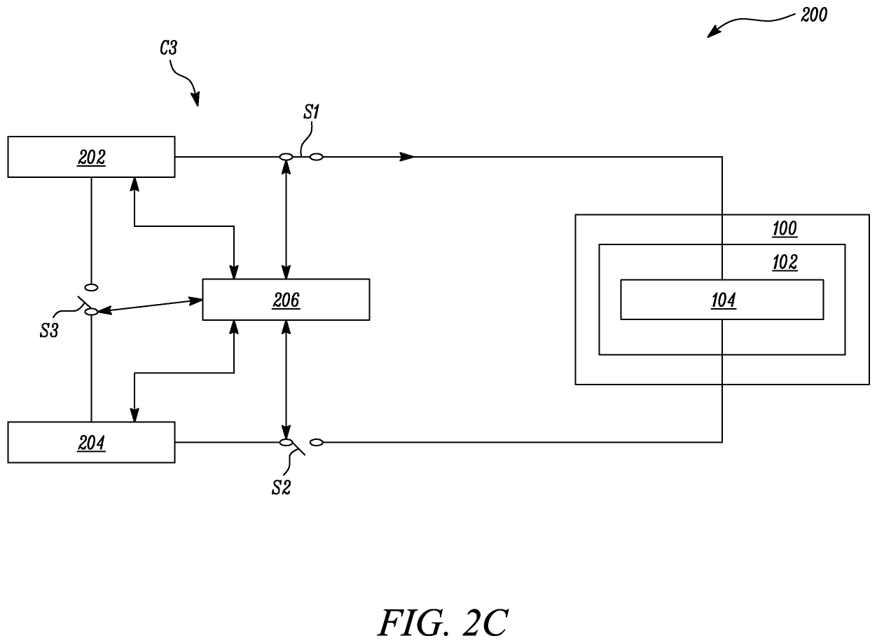

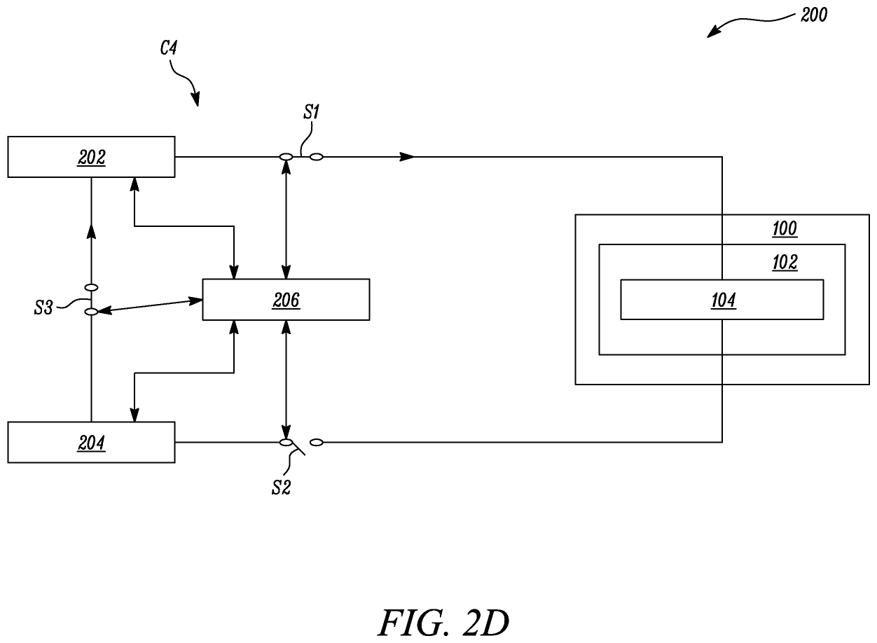

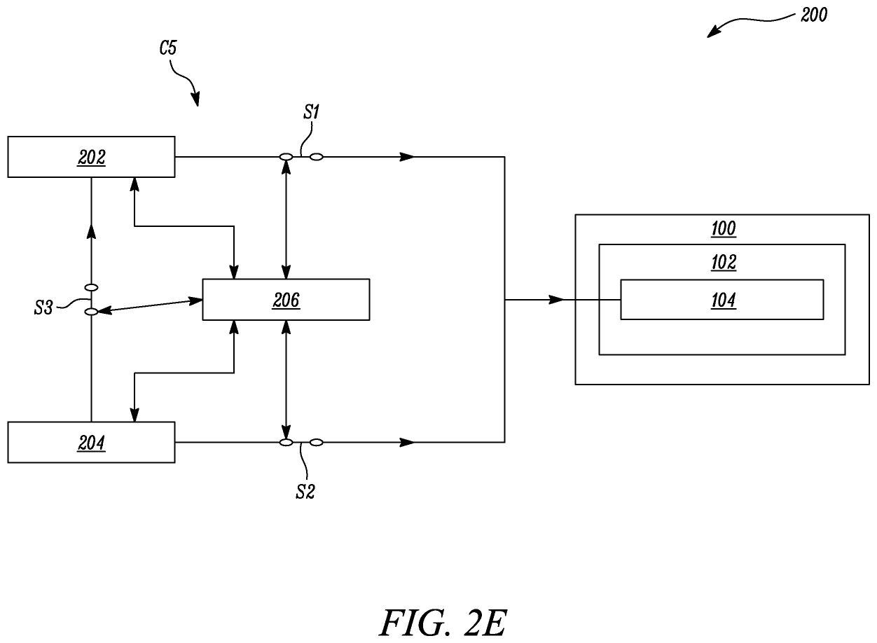

FIG. 2A illustrates a circuit connection C1 between the power supply system 200 and the operating unit 104 of the portable article of PPE 100 of FIG. 1, according to an embodiment of the present disclosure. In the illustrated embodiment of FIG. 2A, the controller 206 is further configured to electrically connect the internal battery pack 202 and the external battery pack 204 to the operating unit 104 in parallel, such that the internal battery pack 202 and the external battery pack 204 simultaneously supply electrical power to the operating unit 104. Therefore, in the circuit connection C1, the internal battery pack 202 and the external battery pack 204 simultaneously supply electrical power to the operating unit 104.

Particularly, as illustrated in FIG. 2A, the internal battery pack 202 supplies electrical power to the portable article of PPE 100 when a switch S1 is closed. Further, the external battery pack 204 supplies electrical power to the portable article of PPE 100 when a switch S2 is closed. Thus, it can be stated that when both the switch S1 and the switch S2 are closed, the internal battery pack 202 as well as the external battery pack 204 simultaneously supply electrical power to the portable article of PPE 100. Furthermore, the external battery pack 204 does not supply electrical power to the internal battery pack 202 when a switch S3 is open. In other words, the portable article of PPE 100 carried by the user is powered via both the internal battery pack 202 and the external battery pack 204 until any one of the internal battery pack 202 and the external battery pack 204 is expended or electrically disconnected from the portable article of PPE 100. Therefore, in the circuit connection C1, the switch S1 is closed, the switch S2 is closed, and the switch S3 is open.

The controller 206 is communicably coupled to each of the switches S1, S2, S3. In some examples, the controller 206 may be coupled to a memory (not shown). The memory may be implemented as an external integrated circuit (IC) or as an internal circuit of the controller 206. In some examples, the memory may be a cache memory, a system memory, or other memory. The memory may store data from one or more sensors and may provide instructions to the controller 206 for the operation of each of the switches S1, S2 and S3. In some examples, each of the switches S1, S2, S3 may be a single pole single throw (SPST) switch, a single pole double throw (SPDT) switch, a double pole single throw (DPST) switch or a double pole double throw (DPDT) switch. Further, the one or more sensors may include sensors for monitoring load parameters and battery parameters (e.g., battery parameters of the internal battery pack 202) of the portable article of PPE 100. The battery parameters may include parameters based on voltage, current, temperature, state of charge of the internal battery pack 202, last or average runtime, or desired runtime by user. In other words, the controller 206 may control the operation (close or open) of each of the switches S1, S2 and S3 based on the data received from the one or more sensors. For example, if a state of charge of the internal battery pack 202 is less than a predetermined charge threshold, or if desired runtime of the portable article of PPE 100 is relatively greater than the normal runtime or runtime remaining of the internal battery pack 202, the controller 206 may accordingly control the switches S2 or S3 to electrically connect/disconnect the external battery pack 204 to any one of the operating unit 104 and the internal battery pack 202. As is apparent from FIG. 2A, the internal battery pack 202 and the external battery pack 204 share the supply of electrical power and simultaneously power the portable article of PPE 100. Therefore, in cases where desired runtime of the portable article of PPE 100 is relatively greater than the normal runtime, the power supply system 200 may allow the internal battery pack 202 and the external battery pack 204 to simultaneously supply electrical power to the portable article of PPE 100.

In another application, power required by the portable article of PPE 100 may be higher than the maximum power that can be supplied by the internal battery pack 202 to the operating unit 104 of the portable article of PPE 100. In such application, any shortfall power may be supplied by the external battery pack 204 to the operating unit 104 of the portable article of PPE 100, while the internal battery pack 202 and the external battery pack 204 are electrically connected to the operating unit 104 in parallel. Therefore, the external battery pack 204 may supplement the power supply to the portable article of PPE 100 when there is high power requirement in the portable article of PPE 100.

FIG. 2B illustrates a circuit connection C2 between the power supply system 200 and the operating unit 104 of the portable article of PPE 100 of FIG. 1, according to another embodiment of the present disclosure. In the illustrated embodiment of FIG. 2B, the controller 206 is further configured to electrically connect the external battery pack 204 to the operating unit 104 while keeping the internal battery pack 202 electrically disconnected from the operating unit 104, such that only the external battery pack 204 supplies electrical power to the operating unit 104. Therefore, in the circuit connection C2, only the external battery pack 204 supplies electrical power to the operating unit 104.

Particularly, as illustrated in FIG. 2B, the internal battery pack 202 does not supply electrical power to the portable article of PPE 100 as the switch S1 is open. Further, the external battery pack 204 supplies electrical power to the portable article of PPE 100 as the switch S2 is closed. Furthermore, the external battery pack 204 does not supply electrical power to the internal battery pack 202 as the switch S3 is open. Thus, it can be stated that only when the switch S2 is closed, the external battery pack 204 supplies electrical power to the portable article of PPE 100. Moreover, the portable article of PPE 100 carried by the user can be powered through the external battery pack 204 until the external battery pack 204 is expended or electrically disconnected from the portable article of PPE 100. Therefore, in the circuit connection C2, the switch S1 is open, the switch S2 is closed, and the switch S3 is open.

Further, the controller 206 is configured to electrically disconnect the internal battery pack 202 from the operating unit 104 if the state of charge of the internal battery pack 202 is less than the predetermined charge threshold. The predetermined charge threshold of the internal battery pack 202 may be 10%, or 20%, or 30% of a total capacity of the internal battery pack 202. Alternatively, the predetermined charge threshold of the internal battery pack 202 may be selected by the user based on various application attributes.

Therefore, in cases where the state of charge of the internal battery pack 202 is less than the predetermined charge threshold, the power supply system 200 may allow the external battery pack 204 to supply electrical power to the portable article of PPE 100.

FIG. 2C illustrates a circuit connection C3 between the power supply system 200 and the operating unit 104 of the portable article of PPE 100 of FIG. 1, according to yet another embodiment of the present disclosure. In the illustrated embodiment of FIG. 2C, the controller 206 is further configured to electrically connect the internal battery pack 202 to the operating unit 104 when the external battery pack 204 is discharged or electrically disconnected from the operating unit 104.

Particularly, as illustrated in FIG. 2C, the internal battery pack 202 supplies electrical power to the portable article of PPE 100 as the switch S1 is closed. Further, the external battery pack 204 does not supply electrical power to the portable article of PPE 100 as the switch S2 is open. Furthermore, the external battery pack 204 does not supply electrical power to the internal battery pack 202 as the switch S3 is open. Thus, it can be stated that only when the switch S1 is closed, the internal battery pack 202 supplies electrical power to the portable article of PPE 100. In other words, the portable article of PPE 100 carried by the user is powered only via the internal battery pack 202 until the internal battery pack 202 is expended. Therefore, in the circuit connection C3, the switch S1 is closed, the switch S2 is open, and the switch S3 is open.

FIG. 2D illustrates a circuit connection C4 between the power supply system 200 and the operating unit 104 of the portable article of PPE 100 of FIG. 1, according to yet another embodiment of the present disclosure. In the illustrated embodiment of FIG. 2D, the controller 206 is further configured to electrically connect the external battery pack 204 to the internal battery pack 202 while keeping the internal battery pack 202 electrically connected to the operating unit 104, such that the internal battery pack 202 supplies electrical power to the operating unit 104 while being charged by the external battery pack 204.

Particularly, as illustrated in FIG. 2D, the internal battery pack 202 supplies electrical power to the portable article of PPE 100 as the switch S1 is closed. Further, the external battery pack 204 does not supply electrical power to the portable article of PPE 100 as the switch S2 is open. Furthermore, the external battery pack 204 supplies electrical power (for charging) to the internal battery pack 202 as the switch S3 is closed. Thus, it can be stated that when both of the switch S1 and the switch S3 are closed and the switch S2 is open, the internal battery pack 202 supplies electrical power to the portable article of PPE 100 while being charged by the external battery pack 204.

Therefore, in cases where the desired runtime of the portable article of PPE 100 is substantially same as the normal runtime, the power supply system 200 may allow the internal battery pack 202 to supply electrical power to the portable article of PPE 100 while the internal battery pack 202 is being charged by the external battery pack 204.

FIG. 2E illustrates a circuit connection C5 between the power supply system 200 and the operating unit 104 of the portable article of PPE 100 of FIG. 1, according to yet another embodiment of the present disclosure. In the illustrated embodiment of FIG. 2E, the controller 206 is further configured to electrically connect the internal battery pack 202 and the external battery pack 204 to the operating unit 104 in parallel while electrically connecting the external battery pack 204 to the internal battery pack 202, such that such that the internal battery pack 202 and the external battery pack 204 simultaneously supply electrical power to the operating unit 104 while the internal battery pack 202 is being charged by the external battery pack 204.

Particularly, as illustrated in FIG. 2E, the internal battery pack 202 supplies electrical power to the portable article of PPE 100 as the switch S1 is closed. Further, the external battery pack 204 also supplies electrical power to the portable article of PPE 100 as the switch S2 is closed. Furthermore, the external battery pack 204 supplies electrical power (for charging) to the internal battery pack 202 as the switch S3 is closed. Thus, it can be stated that when each of the switch S1, the switch S2 and the switch S3 is closed, the internal battery pack 202 as well as external battery pack 204 supply electrical power to the portable article of PPE 100 while the internal battery pack is also being charged by the external battery pack 204.

Therefore, in cases where the desired runtime of the portable article of PPE 100 is greater than the normal runtime, the power supply system 200 may allow both the external battery pack 204 and the internal battery pack 202 to supply electrical power to the portable article of PPE 100 while the internal battery pack 202 is being charged by the external battery pack 204. Further, where the state of charge of the internal battery pack 202 is less than the predetermined charge threshold, the power supply system 200 may allow the external battery pack 204 to charge the internal battery pack 202 as well as supply electrical power to the portable article of PPE 100.

FIG. 3 is a schematic perspective view of the power supply system 200 and the portable article of PPE 100 of FIG. 1, wherein the external battery pack 204 of the power supply system 200 is removably attached to the portable article of PPE 100, according to an embodiment of the present disclosure. The portable article of PPE 100 may be a powered air-purifying respirator (PAPR) as shown in FIG. 3. Only a portion of the PAPR is shown in FIG. 3 for illustrative purposes. Further, the housing 102 of the portable article of PPE 100 is shown as transparent for illustrative purposes. Specifically, the external battery pack 204 is configured to be removably attached to the portable article of PPE 100.

As is apparent from FIGS. 1 and 3, the controller 206 (shown only in FIG. 1) is configured to electrically connect the external battery pack 204 to at least one of the operating unit 104 (shown with dotted lines in FIG. 3) and the internal battery pack 202 (shown with dotted lines in FIG. 3) upon removable attachment of the external battery pack 204 to the portable article of PPE 100.

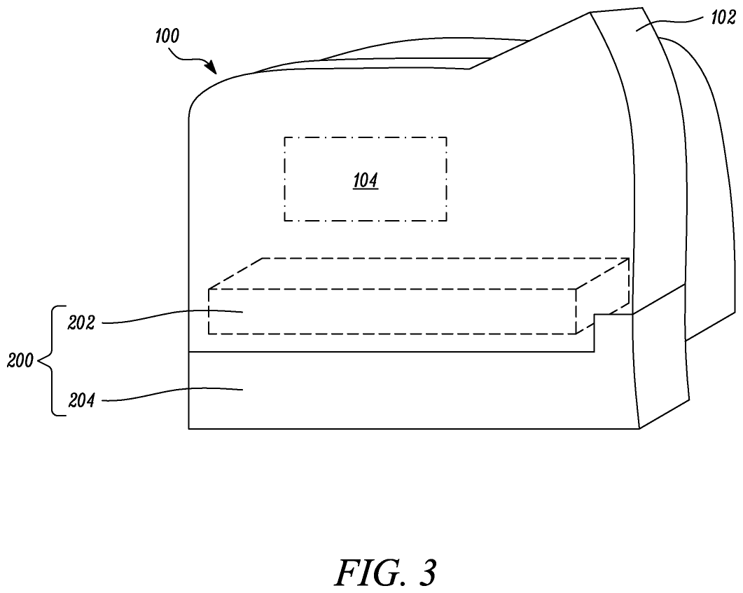

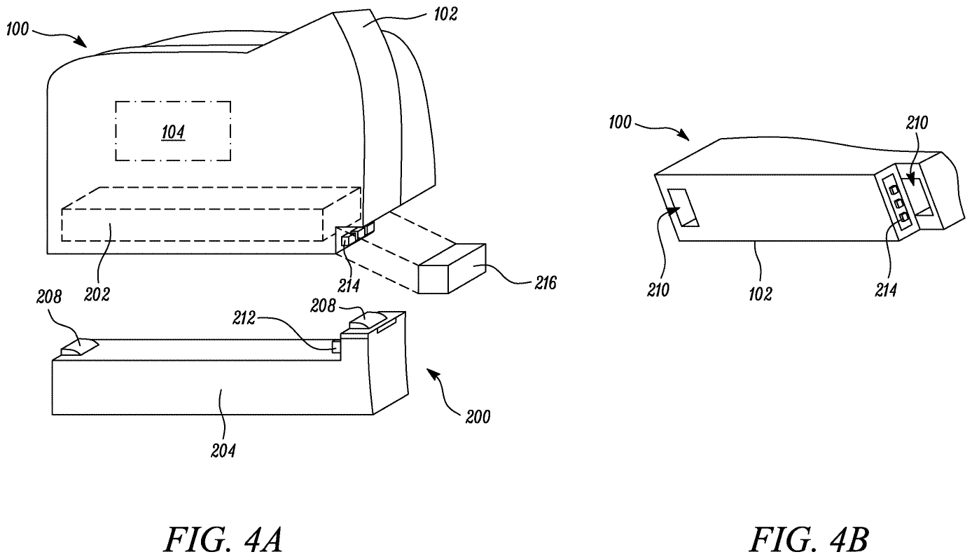

FIG. 4A is a schematic perspective view of the power supply system 200 and the portable article of PPE 100 of FIG. 3, wherein the external battery pack 204 is illustrated as detached from the portable article of PPE 100, according to an embodiment of the present disclosure. In the illustrated embodiment of FIG. 4A, the external battery pack 204 includes a plurality of projections 208.

Further, a plurality of housing terminals 214 are disposed on the housing 102 of the portable article of PPE 100. The power supply system 200 further includes a cover 216 configured to enclose the plurality of housing terminals 214 upon detachment of the external battery pack 204 from the portable article of PPE 100. In the illustrated embodiments of FIGS. 3 and 4A, the cover 216 is removably connected to the housing 102 of the portable article of PPE 100. In other embodiments, the cover 216 may be pivotally connected to the housing 102 of the portable article of PPE 100. The user is allowed to removably attach the external battery pack 204 to the portable article of PPE 100 upon removal of the cover 216 from the housing 102.

In some embodiments, the cover 216 is made of a material that is impervious, non-porous, and corrosion resistant. In other embodiments, the cover 216 may be made of a ceramic, a metallic material, a polymeric material. In some embodiments, the cover 216 has a surface roughness value of about 0.8 μm which may allow the user to easily clean the cover 216. In some embodiments, a radius of curvature of a corner of the cover 216 is at least 3 mm.

The cover 216 protects foreign particles (such as dust and dirt particles) to contact the plurality of housing terminals 214 that can otherwise reduce conductivity of the housing terminals 214. The cover 216 may prevent any damage to the housing terminals 214 by protecting the housing terminals 214 from water splash. Further, preventing the contact of the foreign particles with the housing terminals 214 of the portable article of PPE 100 may also ensure smooth and proper functioning of the portable article of PPE 100 and the external battery pack 204. Moreover, inclusion of the cover 216 may also save a lot of time and effort of an operator who had to otherwise remove/clean the foreign particles manually from the internal components (such as the housing terminals 214) of the portable article of PPE 100. In some applications, the cover 216 may prevent the accumulation of foreign particles in the housing terminals 214 of the portable article of PPE 100 and therefore, prevent the unwanted heating of various components.

FIG. 4B is a schematic bottom perspective view of a portion of the portable article of PPE 100 of FIG. 3. With reference to FIGS. 3, 4A, and 4B, the portable article of PPE 100 includes a plurality of slots 210 disposed on its housing 102. The external battery pack 204 includes a plurality of external terminals 212. A user would remove the cover 216 in order to connect the external battery pack 204 to the portable article of PPE 100. For removable attachment of the external battery pack 204 to the portable article of PPE 100, the plurality of projections 208 are received within corresponding plurality of slots 210 disposed on the housing 102 of the portable article of PPE 100 so as to form a snap-fit connection between the external battery pack 204 and the portable article of PPE 100. In other words, the plurality of slots 210 receive the plurality of projections 208 thereby forming the snap fit connection between the external battery pack 204 and the portable article of PPE 100.

The plurality of external terminals 212 of the external battery pack 204 contact with the plurality of housing terminals 214 of the portable article of PPE 100 upon removable attachment of the external battery pack 204 with the portable article of PPE 100. Therefore, the external battery pack 204 supplies electrical power to the portable article of PPE 100 upon contact of the plurality of external terminals 212 with the plurality of housing terminals 214.

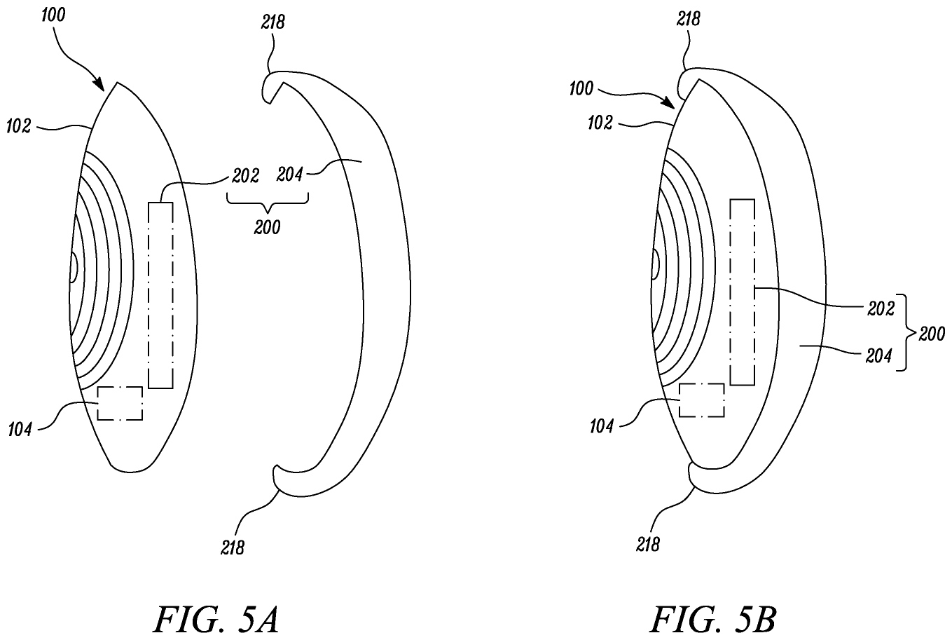

FIG. 5A is a schematic perspective view of the power supply system 200 and the portable article of PPE 100 of FIG. 1, wherein the external battery pack 204 of the power supply system 200 is illustrated as detached from the portable article of PPE 100, according to another embodiment of the present disclosure. Particularly, the portable article of PPE 100 illustrated in FIG. 5A may have different construction and design characteristics than that of the portable article of PPE 100 illustrated in FIG. 3. The external battery pack 204 of the power supply system 200 illustrated in FIG. 5A may have different construction and design characteristics than that of the external battery pack 204 of the power supply system 200 illustrated in FIG. 3. The external battery pack 204 illustrated in FIG. 5A is functionally similar to the external battery pack 204 illustrated in FIG. 3. However, the external battery pack 204 does not include any projection. Instead, the external battery pack 204 includes a plurality of flexible clasping portions 218. Moreover, a portion of the housing 102 of the portable article of PPE 100 is shown as transparent. FIG. 5B is a schematic perspective view of the power supply system 200 and the portable article of PPE 100 of FIG. 5A, wherein the external battery pack 204 is removably attached to the portable article of PPE 100.

With reference to FIGS. 5A and 5B, the flexible clasping portions 218 may be made from a flexible metallic material or a flexible polymeric material. The plurality of flexible clasping portions 218 include a pair of flexible clasping portions 218 disposed on opposite sides of the external battery pack 204. In some other embodiments, the external battery pack 204 may include any number of flexible clasping portions 218.

For removable attachment of the external battery pack 204 to the portable article of PPE 100, the plurality of flexible clasping portions 218 clasp the external battery pack 204 with the housing 102 of the portable article of PPE 100. In other words, in order to connect the external battery pack 204 to the portable article of PPE 100, the user may push the portable article of PPE 100 and the external battery pack 204 towards each other, such that the plurality of flexible clasping portions 218 clasp with the housing 102 of the portable article of PPE 100 to removably attach the external battery pack 204 to the portable article of PPE 100.

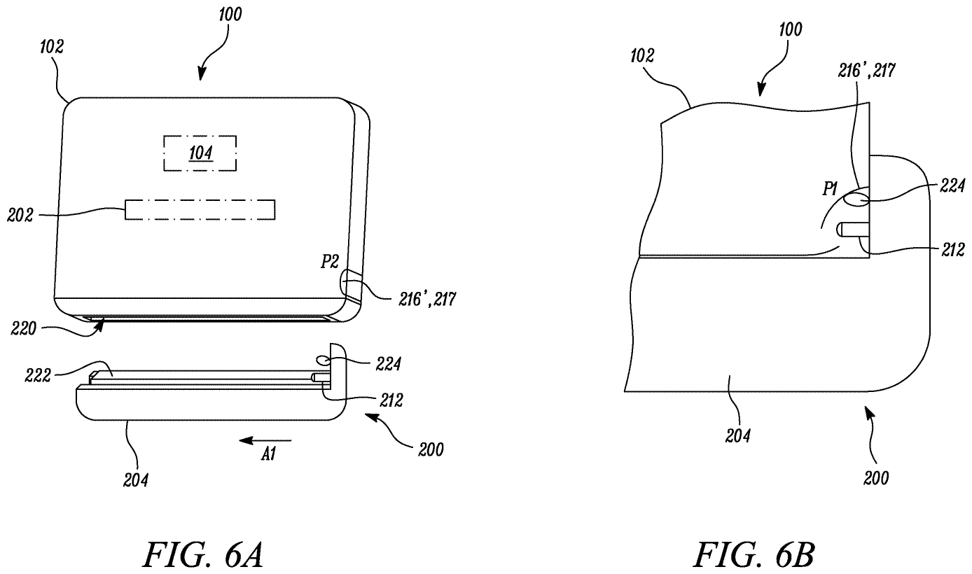

FIG. 6A is a schematic perspective view of the power supply system 200 and the portable article of PPE 100 of FIG. 1, wherein the external battery pack 204 of the power supply system 200 is illustrated as detached from the portable article of PPE 100, according to another embodiment of the present disclosure. Particularly, the portable article of PPE 100 illustrated in FIG. 6A may have different construction and design characteristics than that of the portable article of PPE 100 illustrated in FIG. 3 and the portable article of PPE 100 illustrated in FIG. 5A. The external battery pack 204 of the power supply system 200 illustrated in FIG. 6A may have different construction and design characteristics than that of the external battery pack 204 illustrated in FIG. 3 and the external battery pack illustrated in FIG. 5A. The external battery pack 204 illustrated in FIG. 6A is functionally similar to the external battery pack 204 illustrated in FIG. 3 and the external battery pack 204 illustrated in FIG. 5A. However, the external battery pack 204 does not include any clasping feature and projections (such as projections 208 shown in FIG. 4A). FIG. 6B is a detailed schematic perspective view of the power supply system 200 and the portable article of PPE 100 of FIG. 6A, wherein the external battery pack 204 is removably attached to the portable article of PPE 100. Further, a portion of the housing 102 of the portable article of PPE 100 is illustrated for illustrative purposes.

With reference to FIGS. 6A and 6B, the portable article of PPE 100 includes a plurality of grooves 220 on the housing 102. The external battery pack 204 includes a plurality of rails 222 received within corresponding plurality of grooves 220 on the housing 102 of the portable article of PPE 100 upon sliding (for example in a direction Al) of the external battery pack 204 thereby causing removable attachment of the external battery pack 204 to the portable article of PPE 100. In the illustrated embodiment of FIGS. 6A and 6B, the power supply system 200 further includes a cover 216′ (different from the cover 216 shown in FIG. 4A) configured to enclose the plurality of housing terminals 214 (not shown in FIG. 6A) upon detachment of the external battery pack 204 from the portable article of PPE 100. The cover 216′ is a flap 217 pivotally coupled to the housing 102 and configured to move between an open position P1 and a closed position P2. In FIG. 6A, the flap 217 is shown in the closed position P2. In the closed position P2 of the flap 217, the flap 217 covers the plurality of housing terminals 214 and prevents contact of the housing terminals 214 with the dust particles.

The external battery pack 204 includes a keyed portion 224 configured to allow a movement of the flap 217 from the closed position P2 to the open position P1 during removable attachment of the external battery pack 204 to the portable article of PPE 100. The sliding of the external battery pack 204 causes the keyed portion 224 to move thereby allowing the flap 217 to move from the closed position P2 to the open position P1. In other words, the keyed portion 224 of the external battery pack 204 allows the movement of the flap 217 from the closed position P2 to the open position P1 during removable attachment of the external battery pack 204 to the portable article of PPE 100. In the open position P1 of the flap 217, the plurality of housing terminals 214 are exposed. Further, in the open position P1 of the flap 217, the external terminals 212 of the external battery pack 204 contact the housing terminals 214 disposed on the housing 102 and therefore, allow the supply of electrical power from the external battery pack 204 to the portable article of PPE 100.

Further, upon sliding of the external battery pack 204 along a direction opposite to the direction Al, the external battery pack 204 may be removed from the housing 102, thereby causing the separation of plurality of rails 222 of the external battery pack 204 from the corresponding plurality of grooves 220 of the housing 102. As the flap 217 is pivotally coupled to the housing 102, the flap 217 automatically moves from the open position P1 to the closed position P2 upon removal of the external battery pack 204 from the portable article of PPE 100.

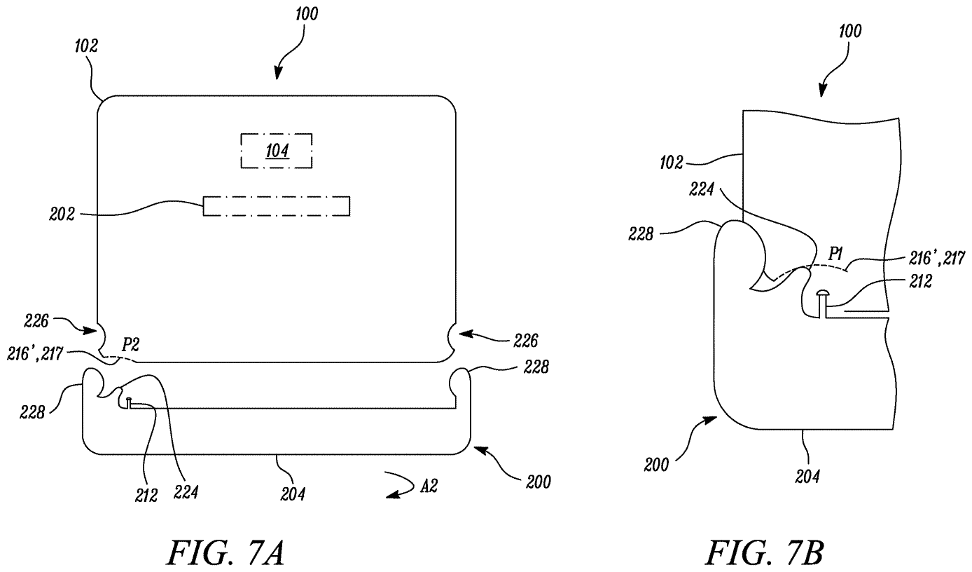

FIG. 7A is a schematic front view of the power supply system 200 and the portable article of PPE 100 of FIG. 1, wherein the external battery pack 204 of the power supply system 200 is illustrated as detached from the portable article of PPE 100, according to another embodiment of the present disclosure. Particularly, the portable article of PPE 100 illustrated in FIG. 7A may have different construction and design characteristics than that of the portable article of PPE 100 illustrated in FIGS. 3 to 6B. The external battery pack 204 of the power supply system 200 illustrated in FIG. 7A may have different construction and design characteristics than that of the external battery pack 204 illustrated in FIGS. 3 to 6B. The external battery pack 204 illustrated in FIG. 6A is functionally similar to the external battery pack 204 illustrated in FIGS. 3 to 6B. However, the external battery pack 204 does not include any clasping feature, projections (such as projections 208 shown in FIG. 4A), and rails (such as the plurality of rails 222 shown in FIG. 6A). FIG. 7B is a detailed schematic front view of the power supply system 200 and the portable article of PPE 100 of FIG. 7A, wherein the external battery pack 204 is removably attached to the portable article of PPE 100. Further, a portion of the housing 102 of the portable article of PPE 100 is illustrated for illustrative purposes.

With reference to FIGS. 7A and 7B, the portable article of PPE 100 includes a plurality of recesses 226 on the housing 102. The external battery pack 204 includes a plurality of protruded portions 228 received within corresponding plurality of recesses 226 disposed on the housing 102 of the portable article of PPE 100 upon rotation (for example in a direction A2) of the external battery pack 204 thereby causing removable attachment of the external battery pack 204 to the portable article of PPE 100. In the illustrated embodiment of FIGS. 7A and 7B, the power supply system 200 further includes the cover 216′ (also shown in FIG. 6A) in the form of the flap 217. In FIG. 7A, the flap 217 is shown in the closed position P2.

The external battery pack 204 further includes the keyed portion 224 (also shown in FIG. 6A). Rotation of the external battery pack 204 causes the keyed portion 224 to move thereby allowing the flap 217 to move from the closed position P2 to the open position P1. In other words, the keyed portion 224 of the external battery pack 204 allows the movement of the flap 217 from the closed position P2 to the open position P1 during removable attachment of the external battery pack 204 to the portable article of PPE 100. In the open position P1 of the flap 217, the plurality of housing terminals 214 are exposed. Further, in the open position P1 of the flap 217, the external terminals 212 of the external battery pack 204 contact the housing terminals 214 disposed on the housing 102 of the portable article of PPE 100 and therefore, allow the supply of electrical power from the external battery pack 204 to the portable article of PPE 100.

Upon rotation of the external battery pack 204 along a direction opposite to the direction A2, the external battery pack 204 may be removed from the housing 102, thereby causing the separation of the plurality of protruded portions 228 from the corresponding plurality of recesses 226 on the housing 102. As the flap 217 is pivotally coupled to the housing 102, the flap 217 automatically moves from the open position P1 to the closed position P2 upon removal of the external battery pack 204 from the portable article of PPE 100.

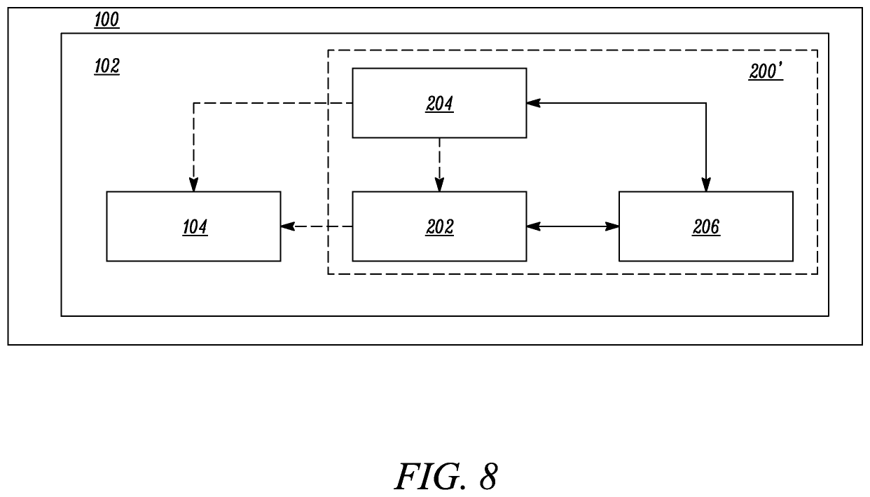

FIG. 8 is a block diagram illustrating a power supply system 200′ for a portable article of PPE 100, according to another embodiment of the present disclosure. The power supply system 200′ is substantially similar and functionally equivalent to the power supply system 200 illustrated in FIG. 1, with common components referred to by the same reference numerals. However, in the power supply system 200′, the external battery pack 204 is fully and removably received (instead of the removable attachment) within the housing 102 of the portable article of PPE 100. Therefore, in the illustrated embodiment of FIG. 8, the article of PPE 100 includes the power supply system 200′.

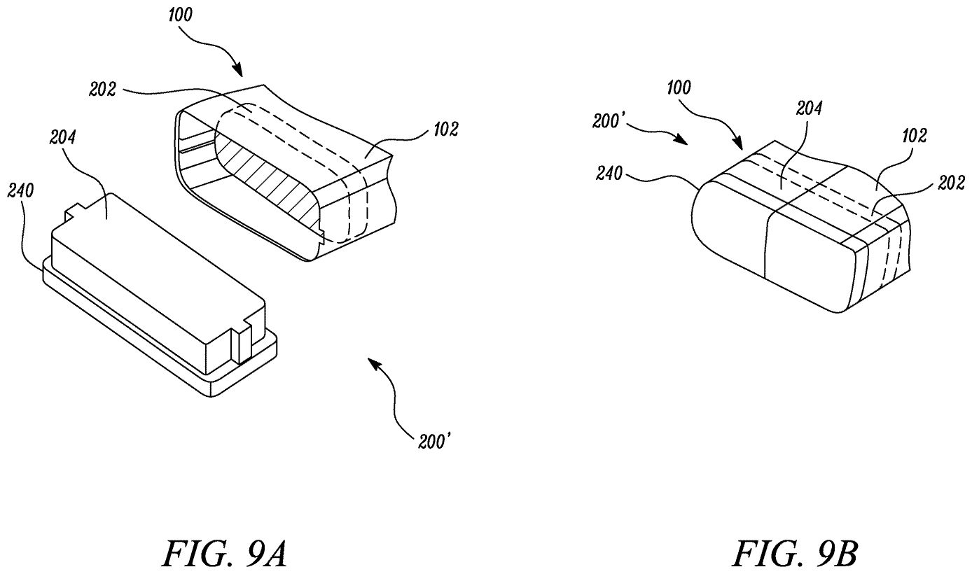

FIG. 9A is a schematic perspective view of the power supply system 200′ and the portable article of PPE 100 of FIG. 8, wherein the external battery pack 204 of the power supply system 200′ is separate from the portable article of PPE 100, according to an embodiment of the present disclosure. Moreover, only a portion of the housing 102 of the portable article of PPE 100 is shown in FIG. 9A for illustrative purposes. Further, some of the components (for example, the operating unit 104) of the portable article of PPE 100 are not shown in FIG. 9A for illustrative purposes.

FIG. 9B is a schematic perspective view of the power supply system 200′ and the portable article of PPE 100 of FIG. 9A, wherein the external battery pack 204 is fully and removably received within the portable article of PPE 100.

With reference to FIGS. 9A and 9B, the power supply system 200′ of the portable article of PPE 100 includes a cover 240 configured to enclose the plurality of housing terminals 214 (shown in FIG. 4A, but not shown in FIG. 9A for illustrative purposes) upon detachment or removal of the external battery pack 204 from the portable article of PPE 100. The cover 240 is a lid. In some examples, the housing 102 and the cover 240 may include corresponding securing features to fully and removably receive and secure the external battery pack 204 within the portable article of PPE 100. In some cases, the cover 240 may include a magnetic latch feature to fully and removably receive and secure the external battery pack 204 within the portable article of PPE 100. In an application, when the cover 240 is removed from the portable article of PPE 100, the user may fully and removably insert the external battery pack 204 so as to connect the external battery pack 204 to at least one of the internal battery pack 202 and the operating unit 104 of the portable article of PPE 100. Further, the cover 240 allows an easy replacement of the external battery pack 204 when the external battery pack 204 either gets expended or when the desired runtime of the portable article of PPE 100 is less than the normal runtime. When the external battery pack 204 is not used, a lid of the same shape as the cover 240 can be used to cover the opening in the portable article of PPE 100, leaving the portable article of PPE 100 smooth and easy to clean.

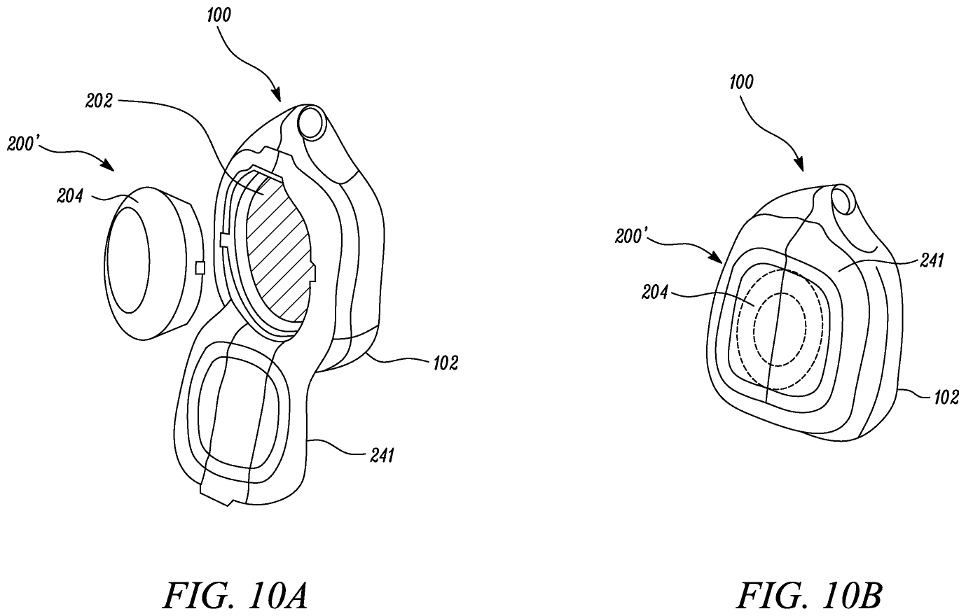

FIG. 10A is a schematic perspective view of the power supply system 200′ and the portable article of PPE 100 of FIG. 8, wherein the external battery pack 204 of the power supply system 200′ is separate from the portable article of PPE 100, according to another embodiment of the present disclosure. Particularly, the portable article of PPE 100 illustrated in FIG. 10A may have different construction and design characteristics than that of the portable article of PPE 100 illustrated in FIG. 9A. Moreover, some of the components (for example, the operating unit 104) of the portable article of PPE 100 are not shown in FIG. 10A for illustrative purposes.

FIG. 10B illustrates a schematic perspective view of the power supply system 200′ and the portable article of PPE 100 of FIG. 10A, wherein the external battery pack 204 is fully and removably received within the portable article of PPE 100.

With reference to FIGS. 10A and 10B, the power supply system 200′ of the portable article of PPE 100 includes a cover 241 configured to enclose the plurality of housing terminals 214 (shown in FIG. 4A, but not shown in FIG. 10A for illustrative purposes) upon detachment or removal of the external battery pack 204 from the portable article of PPE 100. The cover 241 is a door pivotally attached to the housing 102 and allows the insertion of the external battery pack 204 so as to be fully and removably received within the portable article of PPE 100. In an application, when the cover 241 is open (as shown in FIG. 10A), the user may fully and removably insert the external battery pack 204 so as to connect the external battery pack 204 to at least one of the internal battery pack 202 and the operating unit 104 of the portable article of PPE 100. The cover 241 may be closed with the help of some snap-in features provided on the cover 241 and the housing 102 of the portable article of PPE 100. When the external battery pack 204 either gets expended or when the desired runtime of the portable article of PPE 100 is less than the normal runtime, the user may open the cover 241 so as to remove the external battery pack 204 from the portable article of PPE 100.

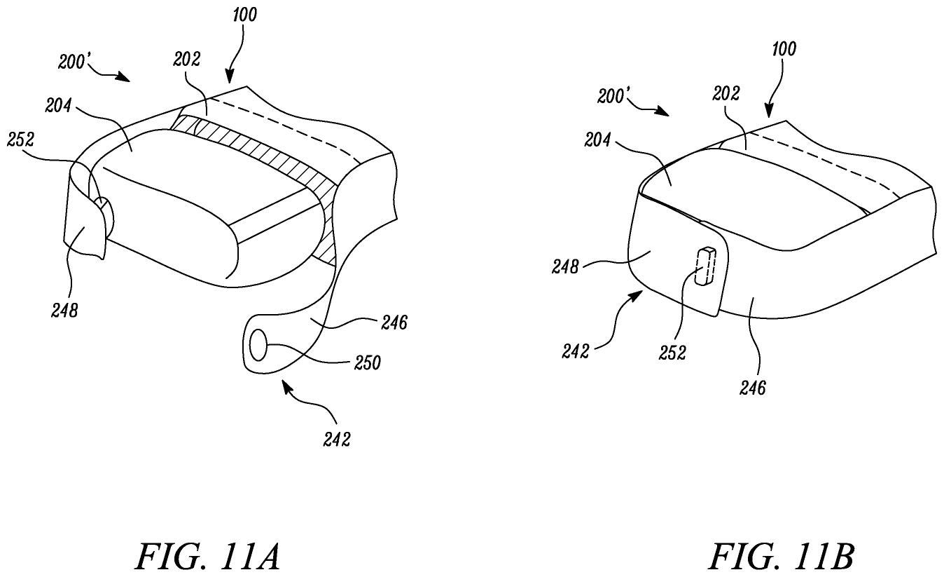

FIG. 11A is a schematic perspective view of the power supply system 200′ and the portable article of PPE 100 of FIG. 8, wherein the external battery pack 204 of the power supply system 200′ is separate from the portable article of PPE 100, according to another embodiment of the present disclosure. Particularly, the portable article of PPE 100 illustrated in FIG. 11A may have different construction and design characteristics than that of the portable article of PPE 100 illustrated in FIGS. 9A and 10A. Moreover, some of the components (for example, the operating unit 104) of the portable article of PPE 100 are not shown in FIG. 11A for illustrative purposes.

FIG. 11B illustrates a schematic perspective view of the power supply system 200′ and the portable article of PPE 100 of FIG. 11A, wherein the external battery pack 204 is fully and removably received within the portable article of PPE 100.

With reference to FIGS. 11A and 11B, the power supply system 200′ of the portable article of PPE 100 includes a cover 242 configured to enclose the plurality of housing terminals 214 (shown in FIG. 4A, but not shown in FIG. 11A for illustrative purposes) upon detachment or removal of the external battery pack 204 from the portable article of PPE 100. The cover 242 includes a first strap 246 and a second strap 248. The first strap 246 includes a groove 250. The second strap 248 includes a protrusion 252. The cover 242 is open when the protrusion 252 is not received within the groove 250, thereby allowing the user to insert the external battery pack 204 within the portable article of PPE 100 or remove the external battery pack 204 from the portable article of PPE 100. Once the external battery pack 204 is fully and removably received within the portable article of PPE 100, the user may close the cover 242 by securing the protrusion 252 within the groove 250 so as to form a snap-fit connection therebetween. When the external battery pack 204 either gets expended or when the desired runtime of the portable article of PPE 100 is less than the normal runtime, the user may open the cover 242 so as to remove the external battery pack 204 from the portable article of PPE 100. Alternatively, when no external battery pack is needed for the portable article of PPE 100 to operate, the first and second straps 246, 248 may be folded across the end of the portable article of PPE 100 and secured together forming a smooth overlap that is easy to clean.

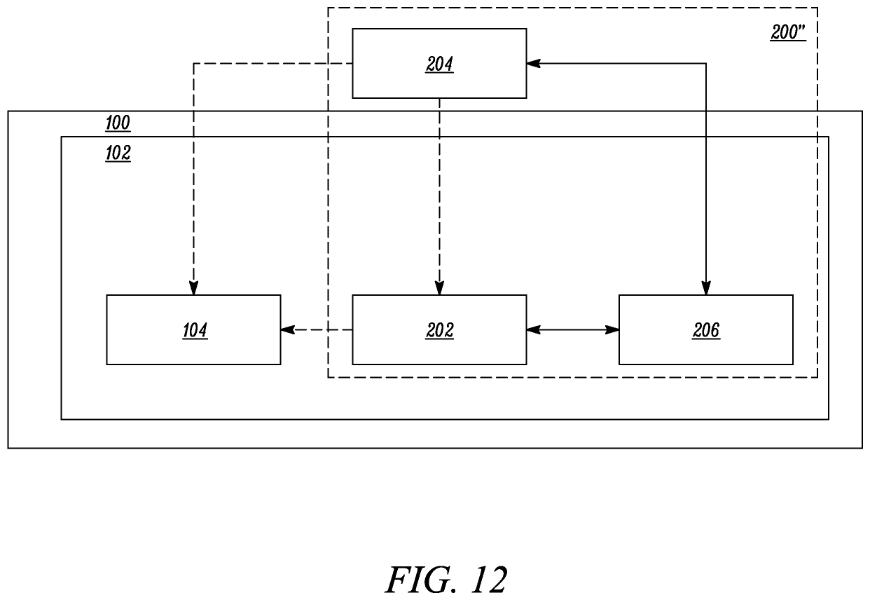

FIG. 12 is a block diagram illustrating a power supply system 200″ for a portable article of PPE 100, according to another embodiment of the present disclosure. The power supply system 200″ is substantially similar and functionally equivalent to the power supply system 200 illustrated in FIG. 1, with common components referred to by the same reference numerals. However, in the power supply system 200′, the external battery pack 204 is remote from the portable article of PPE 100 and is electrically connected to at least one of the operating unit 104 and the internal battery pack 202 via a wireless connection or a wired connection (instead of the removable attachment).

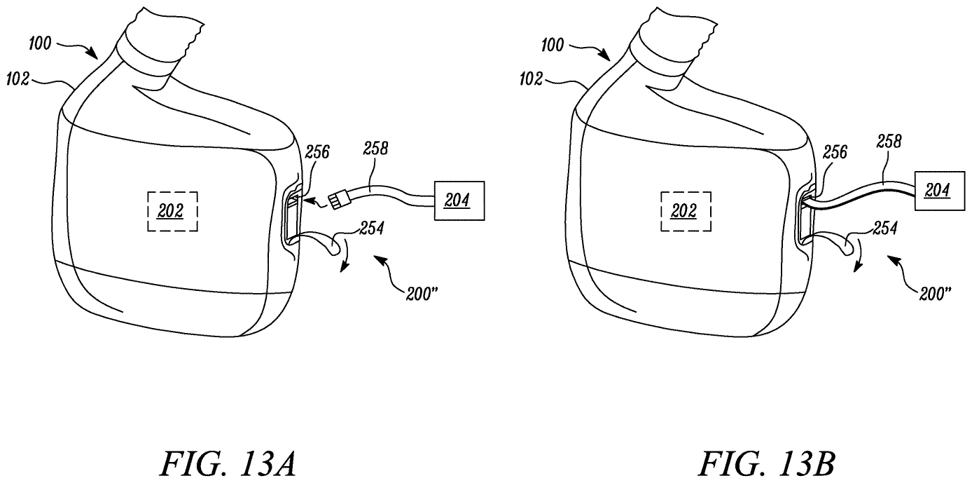

FIG. 13A is a schematic perspective view of the power supply system 200″ and the portable article of PPE of FIG. 12, wherein the external battery pack 204 is electrically disconnected from the portable article of PPE 100, according to an embodiment of the present disclosure. Moreover, only a portion of the housing 102 of the portable article of PPE 100 is shown in FIG. 13A for illustrative purposes. Further, some of the components (for example, the operating unit 104) of the portable article of PPE 100 are not shown in FIG. 13A for illustrative purposes.

FIG. 13B is a schematic perspective view of the power supply system 200″ and the portable article of PPE 100 of FIG. 13A, wherein the external battery pack 204 is electrically connected to the portable article of PPE 100.

With reference to FIGS. 13A and 13B, the power supply system 200″ includes a cover 254 configured to enclose an interface 256 and the plurality of housing terminals 214 (shown in FIG. 4A, but not shown in FIG. 13A for illustrative purposes) when the external battery pack 204 is electrically disconnected from the portable article of PPE 100. In some examples, the interface 256 may be a USB port or a barrel-jack. In some examples, the cover 254 may be a rubber plug that prevents any foreign particles (such as dirt or dust particles) to contact with the interface 256 and the plurality of housing terminals 214. The cover 254 is a door pivotally attached to the housing 102 and allows the external battery pack 204 to electrically connect to the portable article of PPE 100 via a wired connection 258. In some examples, the wired connection 258 may be a USB cable.

In an application, when the cover 254 is open (as shown in FIG. 13A), the user may electrically connect the external battery pack 204 to at least one of the internal battery pack 202 and the operating unit 104 of the portable article of PPE 100. In some examples, the cover 254 may be closed with the help of some snap-in features provided on the cover 254 and the housing 102 of the portable article of PPE 100. When the desired runtime of the portable article of PPE 100 is relatively greater than the normal runtime, the user may connect the external battery pack 204 to the portable article of PPE 100 by connecting the wired connection 258 to the interface 256.

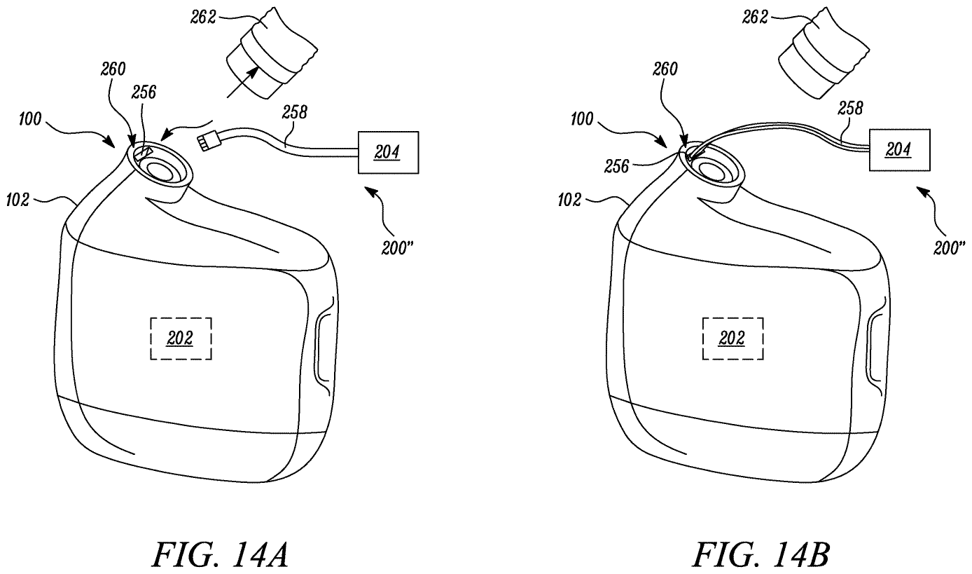

FIG. 14A is a schematic perspective view of the power supply system 200″ and the portable article of PPE 100 of FIG. 12, wherein the external battery pack 204 is electrically disconnected from the portable article of PPE 100, according to another embodiment of the present disclosure. The portable article of PPE 100 illustrated in FIG. 14A may have substantially similar construction and design characteristics to that of the portable article of PPE 100 illustrated in FIG. 13A, with common components referred to by the same numerals. Moreover, some of the components (for example, the operating unit 104) of the portable article of PPE 100 are not shown for illustrative purposes.

FIG. 14B is a schematic perspective view of the power supply system 200″ and the portable article of PPE 100 of FIG. 14A, wherein the external battery pack 204 is electrically connected to the portable article of PPE 100. In the illustrated embodiment of FIGS. 14A and 14B, the portable article of PPE 100 is the PAPR.

With reference to FIGS. 14A and 14B, the portable article of PPE 100 may include the interface 256 in an opening 260. The user may electrically connect the external battery pack 204 to at least one of the internal battery pack 202 and the operating unit 104 of the portable article of PPE 100 via the wired connection 258 by decoupling a flexible hose 262 from the opening 260 of the portable article of PPE 100. In other words, when the internal battery pack 202 of the portable article of PPE 100 gets expended, the user may decouple the flexible hose 262 from the opening 260 and then connect the external battery pack 204 to the portable article of PPE 100 via the wired connection 258 to charge the internal battery pack 202. The flexible hose 262 may be connected to an interior of a helmet (a part of the PAPR but not shown) worn by the user to supply the clean air.

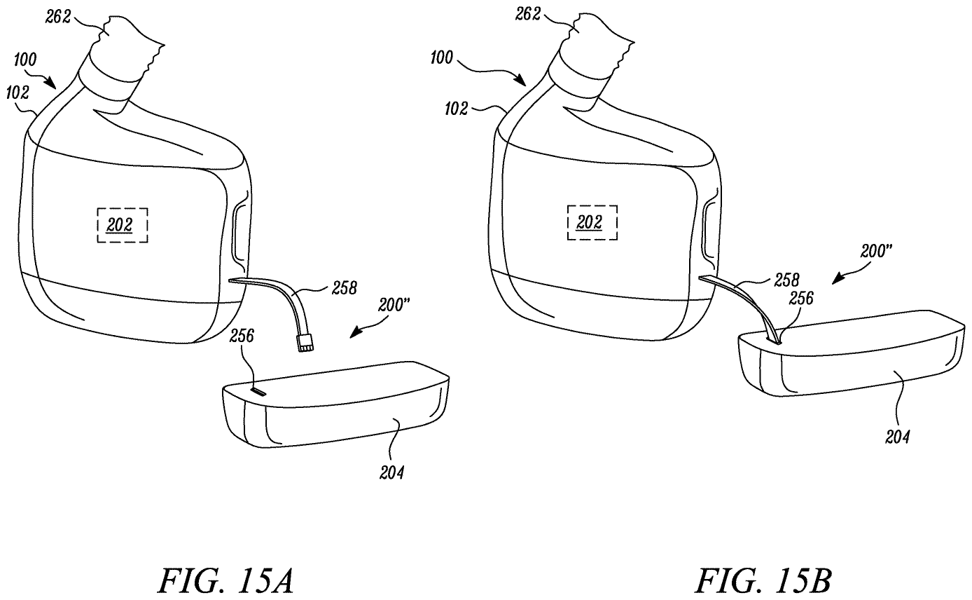

FIG. 15A is a schematic perspective view of the power supply system 200″ and the portable article of PPE 100 of FIG. 12, wherein the external battery pack 204 is electrically disconnected from the portable article of PPE 100, according to another embodiment of the present disclosure. The portable article of PPE 100 illustrated in FIG. 15A may have substantially similar construction and design characteristics to that of the portable article of PPE 100 illustrated in FIG. 13A, with common components referred to by the same numerals. Moreover, some of the components (for example, the operating unit 104) of the portable article of PPE 100 are not shown in FIG. 15A for illustrative purposes.

FIG. 15B is a schematic perspective view of the power supply system 200″ and the portable article of PPE 100 of FIG. 15A, wherein the external battery pack 204 is electrically connected to the portable article of PPE 100.

With reference to FIGS. 15A and 15B, at least a portion of the wired connection 258 is disposed within the portable article of PPE 100 and not directly exposed to ambient environment. In the illustrated embodiment of FIG. 15A, the wired connection 258 is fixedly connected to the housing 102 of the portable article of PPE 100. Further, the external battery pack 204 may include the interface 256 (instead on the housing 102 as shown in FIG. 13A). The user may electrically connect the external battery pack 204 to at least one of the internal battery pack 202 and the operating unit 104 of the portable article of PPE 100 via the wired connection 258.

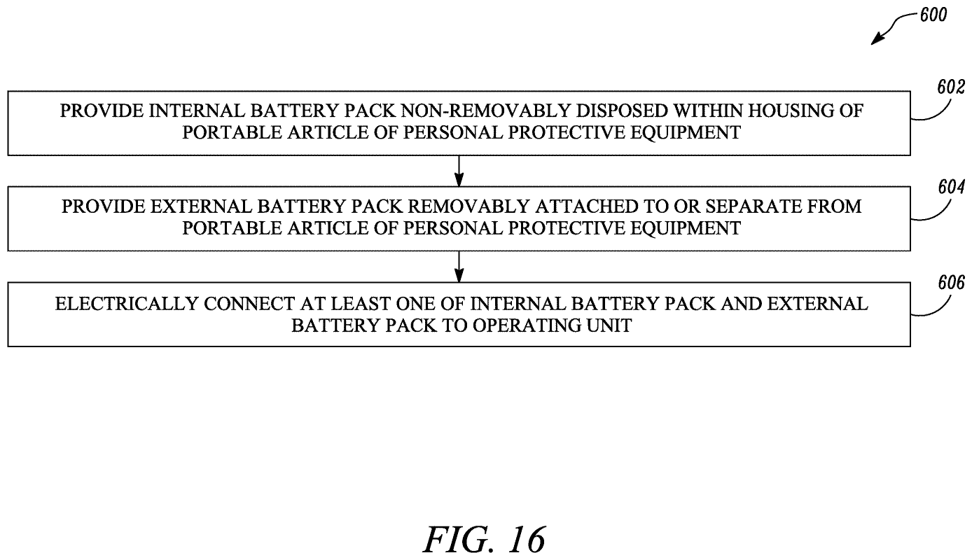

FIG. 16 is a flow chart illustrating a method 600 of powering the portable article of PPE 100 carried by the user, according to an embodiment of the present disclosure. With reference to FIGS. 1 to 15, at step 602, the method 600 incudes providing the internal battery pack 202 non-removably disposed within the housing 102 and configured to selectively supply electrical power to the operating unit 104.

At step 604, the method 600 includes providing the external battery pack 204 configured to be removably attached to or separate from the portable article of PPE 100. The external battery pack 204 is configured to be selectively electrically connected to at least one of the operating unit 104 and the internal battery pack 202. The method 600 further includes removably attaching (shown in FIGS. 1, 3, 5A, 6A, and 7A) the external battery pack 204 to the portable article of PPE 100.

At step 606, the method 600 includes electrically connecting at least one of the internal battery pack 202 and the external battery pack 204 to the operating unit 104, such that the operating unit 104 is electrically powered by at least one of the internal battery pack 202 and the external battery pack 204. As is apparent from FIG. 2A, electrically connecting at least one of the internal battery pack 202 and the external battery pack 204 to the operating unit 104 further includes electrically connecting the internal battery pack 202 and the external battery pack 204 to the operating unit 104 in parallel, such that the internal battery pack 202 and the external battery pack 204 simultaneously supply electrical power to the operating unit 104. As is apparent from FIG. 2B, electrically connecting at least one of the internal battery pack 202 and the external battery pack 204 to the operating unit 104 further includes electrically connecting the external battery pack 204 to the operating unit 104 while keeping the internal battery pack 202 electrically disconnected from the operating unit 104, such that only the external battery pack 204 supplies electrical power to the operating unit 104. As is apparent from FIG. 2C, electrically connecting at least one of the internal battery pack 202 and the external battery pack 204 to the operating unit 104 further includes electrically connecting the internal battery pack 202 to the operating unit 104 when the external battery pack 204 is discharged or electrically disconnected from the operating unit 104. As is apparent from FIG. 2D, electrically connecting at least one of the internal battery pack 202 and the external battery pack 204 to the operating unit 104 further includes electrically connecting the external battery pack 204 to the internal battery pack 202 while keeping the internal battery pack 202 electrically connected to the operating unit 104, such that the internal battery pack 202 supplies electrical power to the operating unit 104 while being charged by the external battery pack 204. As is apparent from FIG. 2E, electrically connecting at least one of the internal battery pack 202 and the external battery pack 204 to the operating unit 104 further includes electrically connecting the internal battery pack 202 and the external battery pack 204 to the operating unit 104 in parallel while electrically connecting the external battery pack 204 to the internal battery pack 202, such that the internal battery pack 202 and the external battery pack 204 simultaneously supply electrical power to the operating unit 104 while the internal battery pack 202 is being charged by the external battery pack 204. The method 600 further includes electrically disconnecting the internal battery pack 202 from the operating unit 104 if the state of charge of the internal battery pack 202 is less than the predetermined charge threshold.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example.

Various examples have been described. These and other examples are within the scope of the following claims.

1. A power portable article of personal protective equipment (PPE) configured to be carried by a user in a work environment having hazardous or potentially hazardous conditions, the portable article of PPE having a housing and an operating unit enclosed by the housing and configured to operate upon supply of electrical power, the portable article of PPE comprising a power supply system comprising:
an internal battery pack non-removably disposed within the housing and configured to selectively supply electrical power to the operating unit;
an external battery pack configured to be removably attached to the portable article of PPE, wherein the external battery pack is configured to be selectively electrically connected to at least one of the operating unit and the internal battery pack; and
a controller communicably coupled to at least the internal battery pack and the external battery pack, wherein the controller is configured to electrically connect at least one of the internal battery pack and the external battery pack to the operating unit, such that the operating unit is electrically powered by at least one of the internal battery pack and the external battery pack;
wherein the portable article of PPE is one of a powered air-purifying respirator (PAPR), a self-contained breathing apparatus (SCBA), a protective headwear, a mining cap lamp, a helmet, or a hearing protection device.

2. The portable article of PPE of claim 1, wherein the controller is further configured to electrically connect the internal battery pack and the external battery pack to the operating unit in parallel, such that the internal battery pack and the external battery pack simultaneously supply electrical power to the operating unit.

3. The portable article of PPE of claim 1, wherein the controller is further configured to electrically connect the external battery pack to the operating unit while keeping the internal battery pack electrically disconnected from the operating unit, such that only the external battery pack supplies electrical power to the operating unit.

4. The portable article of PPE of claim 1, wherein the controller is further configured to electrically disconnect the internal battery pack from the operating unit if a state of charge of the internal battery pack is less than a predetermined charge threshold.

5. The portable article of PPE of claim 1, wherein the controller is further configured to electrically connect the internal battery pack to the operating unit when the external battery pack is discharged or electrically disconnected from the operating unit.

6. The portable article of PPE of claim 1, wherein the controller is further configured to electrically connect the external battery pack to the internal battery pack while keeping the internal battery pack electrically connected to the operating unit, such that the internal battery pack supplies electrical power to the operating unit while being charged by the external battery pack.

7. The portable article of PPE of claim 1, wherein the controller is further configured to electrically connect the internal battery pack and the external battery pack to the operating unit in parallel while electrically connecting the external battery pack to the internal pack, such that such that the internal battery pack and the external battery pack simultaneously supply electrical power to the operating unit while the internal battery pack is being charged by the external battery pack.

8. The portable article of PPE of claim 1, wherein the controller is further configured to electrically connect the external battery pack to at least one of the operating unit and the internal battery pack upon removable attachment of the external battery pack to the portable article of PPE.

9. The portable article of PPE of claim 8, wherein the external battery pack comprises a plurality of projections, and wherein, for removable attachment of the external battery pack to the portable article of PPE, the plurality of projections are received within corresponding plurality of slots disposed on the housing of the portable article of PPE so as to form a snap-fit connection between the external battery pack and the portable article of PPE.

10. The portable article of PPE of claim 8, wherein the external battery pack comprises a plurality of flexible clasping portions, and wherein, for removable attachment of the external battery pack to the portable article of PPE, the plurality of flexible clasping portions clasp the external battery pack with the housing of the portable article of PPE.

11. The portable article of PPE of claim 8, wherein:
the external battery pack comprises a plurality of external terminals;
a plurality of housing terminals are disposed on the housing of the portable article of PPE; and
the plurality of external terminals contact with the plurality of housing terminals upon removable attachment of the external battery pack with the portable article of PPE.

12. The portable article of PPE of claim 11, further comprising a cover configured to enclose the plurality of housing terminals upon detachment of the external battery pack from the portable article of PPE.

13. The portable article of PPE of claim 12, wherein the cover is removably connected to the housing, and wherein the user is allowed to removably attach the external battery pack to the portable article of PPE upon removal of the cover from the housing.

14. The portable article of PPE of claim 12, wherein the cover is a flap pivotally coupled to the housing and configured to move between an open position and a closed position, wherein, in the closed position of the flap, the flap covers the plurality of housing terminals, and wherein, in the open position of the flap, the plurality of housing terminals are exposed.

15. The portable article of PPE of claim 14, wherein the external battery pack comprises a keyed portion configured to allow a movement of the flap from the closed position to the open position during removable attachment of the external battery pack to the portable article of PPE.

16. The portable article of PPE of claim 15, wherein the external battery pack further comprises a plurality of rails, wherein:
the plurality of rails are received within corresponding plurality of grooves on the housing of the portable article of PPE upon sliding of the external battery pack thereby causing removable attachment of the external battery pack to the portable article of PPE; and
sliding of the external battery pack causes the keyed portion to move thereby allowing the flap to move from the closed position to the open position.

17. The portable article of PPE of claim 15, wherein the external battery pack further comprises a plurality of protruded portions, wherein:
the plurality of protruded portions are received within corresponding plurality of recesses on the housing of the portable article of PPE upon rotation of the external battery pack thereby causing removable attachment of the external battery pack to the portable article of PPE; and
rotation of the external battery pack causes the keyed portion to move thereby allowing the flap to move from the closed position to the open position.

18. The portable article of PPE of claim 14, wherein the flap automatically moves from the open position to the closed position upon removal of the external battery pack from the portable article of PPE.

19-22. (canceled)

23. The portable article of PPE of claim 1, wherein the external battery pack is electrically connected to at least one of the operating unit and the internal battery pack via a wireless connection or a wired connection.

24. The portable article of PPE of claim 23, wherein at least a portion of the wired connection is disposed within the portable article of PPE and not directly exposed to ambient environment.

25-37. (canceled)
